(19) United States
(12) Patent Application Publication
(10) Pub. No.: US 2006/0215708 A1
(43) Pub. Date: Sep. 28, 2006

(54) Signaling/control transport

(75) Inventors: Gerald Lebizay, Las Vegas, NV (US); Henry M. Mitchel, Wayne, NJ (US)

Correspondence Address: SCHWABE, WILLIAMSON & WYATT, PACWEST CENTER, SUITE 1900, 1211 S.W. FIFTH AVE., PORTLAND, OR, 97204, US

(73) Assignee: Intel Corporation

(21) Appl. No.: 11/090,746

(22) Filed: Mar. 24, 2005

(51) Int. Cl. H04J 3/12; H04J 3/04

(52) U.S. Cl. 370/535; 370/522

(57) ABSTRACT

A method of operation in a communications node is disclosed. The method of operation includes combining a first of a plurality of latency sensitive signaling/control traffic with a first of a plurality of latency sensitive data, and transmitting the first latency sensitive signaling/control traffic in combination with the first latency sensitive data. Embodiments of the present invention include but are not limited to communications nodes and devices, subsystems, and systems equipped to operate in the above described manner.

### FIELD

Disclosed embodiments of the present invention relate generally to the field of communications, and more particularly to the transport of signaling/control information.

### BACKGROUND

Information being transmitted by communications nodes over a network may be sensitive to latency. Examples of such information may include data traffic and signaling/control traffic. Some communications networks may include both fixed and mobile nodes. In such a communications network, mobile nodes may dynamically access fixed nodes based on a number of factors, such as, for example, proximity. Mobile nodes switching from one fixed node to another fixed node may involve the transport of latency sensitive information over at least part of a communications network.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 is a block diagram illustrating some of the functional blocks of a wireless network, in accordance with an embodiment of this invention;

FIG. 2 is a block diagram illustrating some of the functional blocks of a communications network, in accordance with an embodiment of this invention;

FIG. 3 is a block diagram illustrating some of the functional blocks of a communications node, in accordance with an embodiment of this invention; and

FIG. 4 is a block diagram illustrating some of the functional blocks of a communications node, in accordance with an embodiment of this invention.

### DETAILED DESCRIPTION OF ILLUSTRATIVE EMBODIMENTS

Embodiments of the present invention include but are not limited to a method of operation in a communications node. The method of operation includes combining a first of a plurality of latency sensitive signaling/control traffic with a first of a plurality of latency sensitive data, and transmitting the first latency sensitive signaling/control traffic in combination with the first latency sensitive data. Embodiments of the present invention include but are not limited to communications nodes and devices, subsystems, and systems equipped to operate in the above-described manner. The following discussion is primarily presented in the context of networks that are at least partially wireless. It is understood that the principles described herein may apply to other networks.

In the following description, various aspects of embodiments of the present invention will be described. However, it will be apparent to those skilled in the art that other embodiments may be practiced with only some or all of the described aspects. For purposes of explanation, specific numbers, materials and configurations are set forth in order to provide a thorough understanding of the embodiments. However, it will be apparent to one skilled in the art that other embodiments may be practiced without the specific details. In other instances, well-known features are omitted or simplified in order not to obscure the description.

Various operations will be described as multiple discrete operations in turn, in a manner that is most helpful in understanding the embodiments, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising,” “having” and “including” are synonymous, unless the context dictates otherwise.

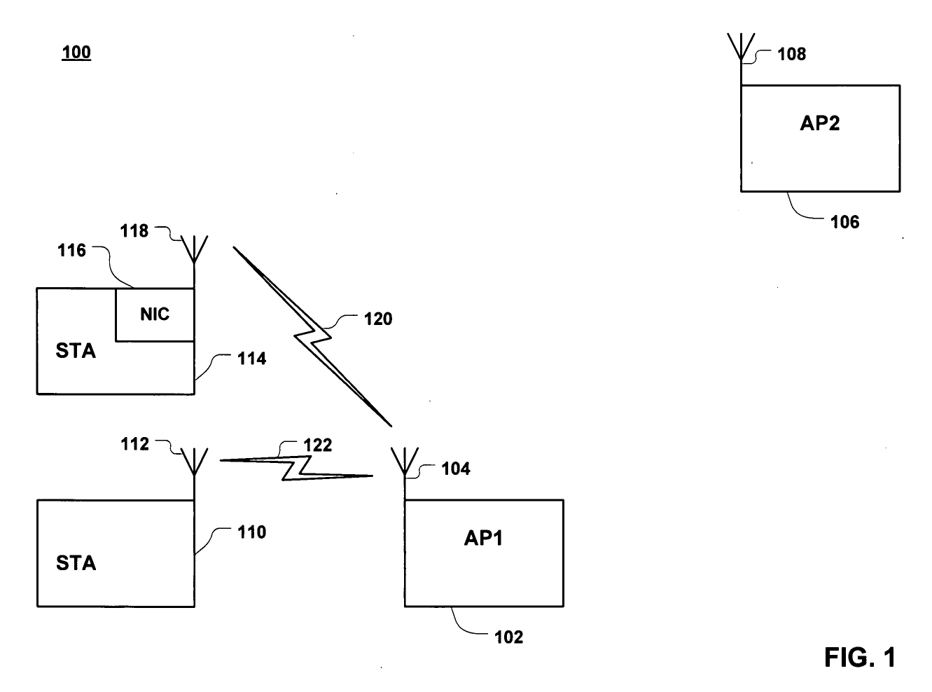

FIG. 1 is a block diagram illustrating some of the functional blocks of a wireless network 100, in accordance with an embodiment of this invention. As illustrated, part of a wireless network may comprise access points (AP) 102 and 106, designated AP1 and AP2, respectively, and stations (STA) 110 and 114. In some embodiments, AP1 102, AP2 106, and STAs 110 and 114 may include antennas 104, 108, 112, and 118, respectively. In alternative embodiments, other means for relaying signals between an AP and a STA may be used, for example, infrared transmitters and detectors. AP1 102 may serve as a point of network access for STAs 110 and 114.

In various applications, one or more STAs 110 and 114 may comprise a network interface card (NIC), a cellular phone, a personal digital assistant (PDA), a handheld computer, a laptop computer, a personal computer, a set-top box, a handheld gaming device, a game console, a video display, a video camera, or any such device that may make use of network access.

At least one of STAs 110 and 114 maybe mobile and AP2 106 may also serve as a point of network access for at least one of STAs 110 and 114. Switching from one AP to another AP may be performed in accordance with the protocol being used to form the connection between an AP and a STA. In some embodiments, for example, if STA 114 were moved to a position of closer proximity to AP2 106 than to AP1 102, with such a new position allowing for a higher throughput transmission between STA 114 and AP2 106 than between STA 114 and AP1 102, STA 114 may terminate a connection with AP1 102 and form a connection with AP2 106. In various other embodiments, different factors and methods may be involved in switching between network nodes.

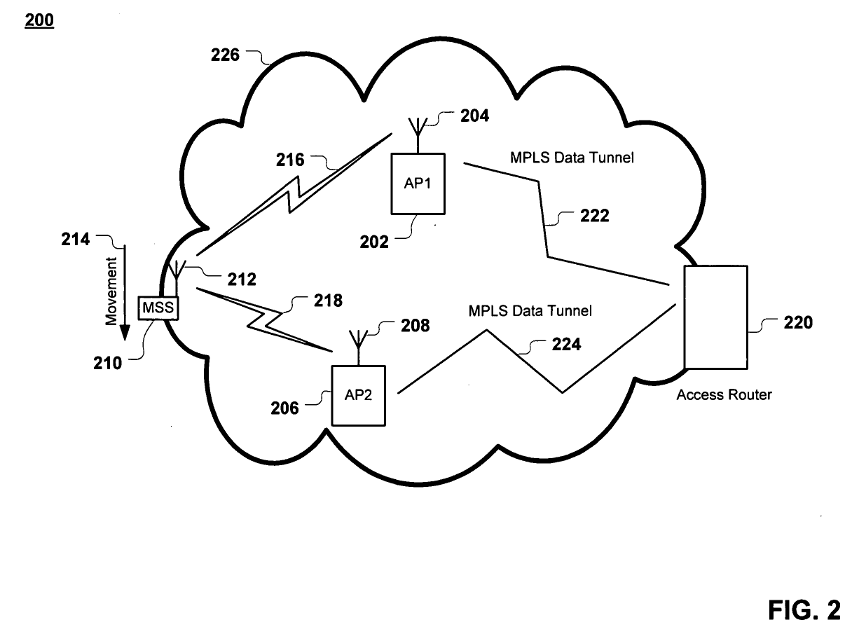

In various embodiments, STA 114 may transmit or receive latency sensitive data. In some embodiments, such latency sensitive data may be associated with an application. STA 114 may support such an application while switching from one AP to another AP. For example, streaming video being transmitted to STA 114 through AP1 102 from another communications node in a network (not shown) may comprise latency sensitive data. STA 114 may physically move such that accessing the network through AP2 106 may be more advantageous than accessing the network through AP1 102. STA 114 may switch from accessing the network through AP1 102 to accessing the network through AP2 106 while receiving the streaming video. The information relating to the switch of AP1 102 to AP2 106 in the transmission path may comprise latency sensitive signaling/control traffic. Various methods of transmitting such latency sensitive signaling/control traffic will be described by way of the illustrative embodiment of FIG. 2.

In some embodiments, the network accessed by a STA may be a local area network (LAN) with an AP being connected to such a network via a fixed line or some other means, including a wireless link (not shown). In other embodiments, other types of networks may be involved. In various embodiments, AP1 102, AP2 106, and at least one of STAs 110 or 114 may be compliant or compatible with the Institute of Electrical and Electronics Engineers (IEEE) 802.11 standard, IEEE std. 802.11-1999, reaffirmed Jun. 12, 2003, forming an 802.11 network. The term, 802.11, will be used herein to refer to all IEEE 802.11 standards, including past, present, and future versions. In various embodiments, AP1 102, AP2 106, and at least one of STAs 110 or 114 may be compliant or compatible with the Institute of Electrical and Electronics Engineers (IEEE) 802.16 standard, IEEE std. 802.16-2001, published Apr. 8, 2002, forming an 802.16 network. The term, 802.16, will be used herein to refer to all IEEE 802.16 standards, including past, present, and future versions. In various embodiments, the network may support both 802.11 and 802.16 standards. In various embodiments, the network may additionally or alternatively comply with other communication standards.

While the embodiment in FIG. 1 shows two APs, other embodiments may include a different number of APs. In various embodiments, an AP may serve as a hub in a hub-and-spoke configuration. In various other embodiments, multiple APs may form a mesh network in a mesh configuration. A STA may include a NIC that provides the STA with the functionality to access a wireless network, as illustrated in STA 114 including NIC 116. While the embodiment in FIG. 1 shows two STAs, other embodiments may include a different number of STAs.

AP1 102 may communicate with STAs 110 and 114 via signals 122 and 120, respectively. Signals 122 and 120 may utilize one or more of a number of available channels. A channel in a communications medium may be defined in any number of ways, including a frequency band, a time period, a coding scheme (for example, in embodiments making use of spread spectrum techniques), a combination of spatial and other information, and the like, including multiple combinations of differentiating a communications medium. Channels are defined in various ways for particular communications protocols, and various embodiments may make use of various communications protocols.

FIG. 2 is a block diagram illustrating some of the functional blocks of a communications network 200, in accordance with an embodiment of this invention. Mobile Subscriber Station (MSS) 210 may access AP1 202 or AP2 206 via wireless links 216 or 218, respectively. A MSS may comprise a STA that is capable of being mobile. In the example embodiment of a network illustrated in FIG. 2, AP1 202, AP2 206, and MSS 210 may include antennas 204, 208, and 212, respectively, with which to communicate with via radio frequency transmissions 216 and 218. In various other embodiments, the communications nodes operating to connect a mobile device to a network may comprise basestations. In other embodiments, other types of communication nodes may be utilized.

In some embodiments, communications node AP1 202, residing in part of network 226, may operate to combine a first of a plurality of latency sensitive signaling/control traffic with a first of a plurality of latency sensitive data. Network 226 may comprise part of a larger network (not shown). AP1 202 may also operate to transmit the first latency sensitive signaling/control traffic in combination with the first latency sensitive data. In various embodiments, another communications node in the network, Access Router 220 for example, may receive such transmissions. In various embodiments, Access Router 220 may transmit back to AP 1 202 in a like manner.

In various embodiments, the plurality of latency sensitive data and the plurality of latency sensitive signaling/control traffic may comprise packets to be transmitted over a network in compliance or compatible with an Internet Protocol (IP), such as specified in the Internet Protocol Defense Advanced Research Projects Agency (DARPA) Internet Program Specification Request for Comments (RFC) 791, prepared for DARPA and published in September, 1981 by the Information Sciences Institute of the University of Southern California. The term, IP, will be used herein to refer to all IP standards, including past, present, and future versions. In some embodiments, such packet-based transmissions may occur between AP1 202 and Access Router 220, and may be made in compliance or compatible with Multiprotocol Label Switching (MPLS) Architecture, such as specified in the Multiprotocol Label Switching Architecture RFC 3031, prepared by the Network Working Group of the Internet Society, published in January 2001. The term, MPLS, will be used herein to refer to all MPLS standards, including past, present, and future versions. The transmissions between AP1 202 and Access Router 220, and between AP2 206 and Access Router 220, may comprise MPLS data tunnels 222 and 224, respectively. MPLS transmissions may make use of Forwarding Equivalency Classes (FEC), such as, for example, Expedited Forwarding (EF), Assured Forwarding (AF), and Best Effort (BE), listed in order of highest priority to lowest priority. In other embodiments, other transmission standards or methods may be utilized. In other embodiments, different ways of designating priority may be utilized.

In various embodiments, MSS 210 may transmit or receive latency sensitive data. In some embodiments, such latency sensitive data may be associated with an application. MSS 210 may support such an application while switching from one AP to another AP. For example, streaming video being transmitted to MSS 210 through Access Router 220 from another communications node in a network (not shown) may comprise latency sensitive data. The transmission from Access Router 220 may be initially routed through AP1 202 due to, for example, physical proximity to MSS 210. MSS 210 may move, as illustrated by arrow 214, such that accessing Access Router 220 through AP2 206 may be more advantageous than accessing Access Router 220 through AP 1 202. This switching of part of the physical connection between Access Router 220 and MSS 210 may not comprise a switching of the logical connection between Access Router 220 and MSS 210, and may occur while latency sensitive data, such as streaming video, is being transmitted to MSS 210.

In some embodiments, latency sensitive data may be transmitted in a high priority FEC to ensure timely transport of the data. To continue the example embodiment used above for illustrative purposes, streaming video may be transmitted in a high priority FEC, such as EF, to ensure data for each video frame arrives in time for proper display. The information relating to the switch of AP1 202 to AP2 206 in the transmission path may comprise latency sensitive signaling/control traffic. In some embodiments, a portion of such latency sensitive signaling/control traffic may be transmitted in the same MPLS data tunnel being used for the transmission of latency sensitive data, and may be classified under the same FEC. In various embodiments, an application supporting voice may be used, with the voice data comprising latency sensitive data, and the device handover information, for example, comprising latency sensitive signaling/control traffic. In various other embodiments, other types of latency sensitive data and latency sensitive signaling/control traffic may be transmitted.

In some embodiments, the plurality of latency sensitive signaling/control traffic may have latency sensitivity in excess of an upper latency threshold of the signaling/control traffic. Such a latency sensitivity threshold may be specified in many different ways, including maximum time permitted for transmission between two communications nodes, for example. In various embodiments, a communications node such as AP1 202 may be adapted to determine whether both latency sensitive data and latency sensitive signaling/control traffic are pending transmission, with the combining and transmitting in combination operations being performed in response to an affirmative result of the determination operation. In various embodiments, the determination operation may be at least partially based on an accumulated quantity of pending signaling/control traffic. In some embodiments, such an accumulated quantity of pending signaling/control traffic may be at least partially queued at AP1 202.

In some embodiments, the plurality of latency sensitive signaling/control traffic may comprise a defined subset of possible signaling/control traffic. In some embodiments, for example, the defined subset of possible signaling/control traffic designated as latency sensitive signaling/control traffic may comprise several specific signaling/control transmissions. In some other embodiments, the defined subset of possible signaling/control traffic may comprise one specific signaling/control transmission, such as, for example, an Acknowledge (ACK) of a MSS handover from one fixed communications node to another fixed communications node. In one illustration of such an embodiment, only the ACK of a MSS handover from AP1 202 to AP2 206 may be permitted to be placed in an MPLS data tunnel to Access Router 220. In various other embodiments, other signaling/control traffic may comprise the defined subset of possible signaling/control traffic permitted to be placed in the MPLS data tunnel. In various embodiments with an FEC being used that may involve clipping traffic, such as EF, the defined subset of possible signaling/control traffic may be determined at least partially based on the probability of the signaling/control traffic being clipped.

In some embodiments, a communications node in the network, such as AP1 202 for example, may operate to combine a first of a plurality of latency sensitive signaling/control traffic with a second of a plurality of latency sensitive data. The communications node in the network, such as AP1 202, may also operate to transmit the first latency sensitive signaling/control traffic in combination with the second latency sensitive data. In various embodiments, another communications node in the network, such as Access Router 202 for example, may receive such transmissions and may transmit back to AP1 202 in a like manner. To use the example embodiment mentioned above for illustration purposes, where the ACK is combined with the latency sensitive data, the ACK may be placed with multiple latency sensitive data transmissions in some embodiments to help facilitate a rapid, or even the most rapid possible, delivery of the ACK traffic. In other embodiments, additional or other signaling/control traffic may be used.

In various embodiments, AP1 202 may be adapted to support data of a plurality of priority classes, with designated latency sensitive data having priority classes above a priority class threshold. In some embodiments, the designated latency sensitive data may have a real-time priority class, such as EF, for example. In various embodiments, the first latency sensitive signaling/control traffic may be associated with the first latency sensitive data. For example, MSS 210 may support multiple applications at once, with multiple data streams associated with the multiple applications. One data stream may comprise latency sensitive data, with its associated application involving location-based services, based on the access point or basestation being accessed. The signaling/control data regarding switching access points or basestations may be included in the data transmission dealing with the located-based application. In various other embodiments, the first latency sensitive signaling/control traffic may be associated with the first latency sensitive data in other ways.

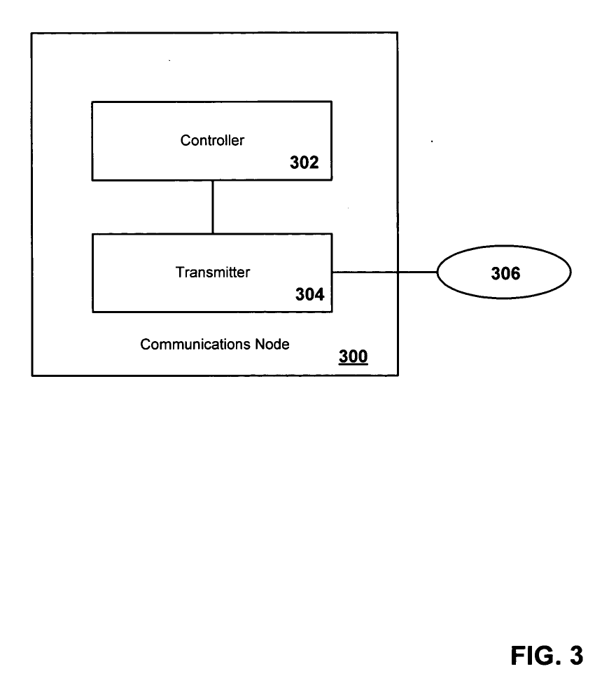

FIG. 3 is a block diagram illustrating some of the functional blocks of a communications node 300, in accordance with an embodiment of this invention. In various embodiments, communications node 300 may include controller block 302. Controller block 302 may be coupled to transmitter block 304. In various embodiments, controller block 302 may be adapted to combine a first of a plurality of latency sensitive signaling/control traffic with a first of a plurality of latency sensitive data. In various embodiments, controller block 302 may be adapted to control transmitter block 304 to transmit the first latency sensitive signaling/control traffic in combination with the first latency sensitive data. In various embodiments, controller block 302 may be adapted to consider signaling/control traffic having latency sensitivity in excess of an upper latency threshold as latency sensitive signaling/control traffic. Such a latency sensitivity threshold may be specified in many different ways, including maximum time permitted for transmission between two communications nodes, for example.

In various embodiments, controller block 302 may be adapted to determine whether both latency sensitive data and latency sensitive signaling/control traffic are pending transmission. In some embodiments, controller block 302 may be adapted to perform the combining and the controlling of transmitter block 304 to transmit in combination, in response to an affirmative result of the determination operation. In various embodiments, controller block 302 may be adapted to perform said determining at least partially based on an accumulated quantity of pending signaling/control traffic.

In various embodiments, controller block 302 may be adapted to support a plurality of signaling/control traffic. Controller block 302 may also be adapted to consider a defined subset of the signaling/control traffic as latency sensitive signaling/control traffic. In some embodiments, for example, the defined subset of signaling/control traffic designated as latency sensitive signaling/control traffic may comprise several specific signaling/control transmissions. In some other embodiments, the defined subset of signaling/control traffic may comprise one specific signaling/control transmission, such as, for example, an Acknowledge (ACK) of a MSS handover from one fixed communications node to another fixed communications node. In some embodiments, communications node 300 may be at least part of a radio access network. In some embodiments, communications node 300 may include an additional transmitter (not shown). In some embodiments, communications node 300 may include at least one antenna (not shown).

In various embodiments, controller block 302 may be adapted to support data of a plurality of priority classes, with the first latency sensitive data having a real-time priority class. In one embodiment, such a real-time priority class may be EF. In various embodiments, controller block 302 may be adapted to combine the first of a plurality of latency sensitive signaling/control traffic with a second of a plurality of latency sensitive data. Controller block 302 may be adapted to control transmitter block 304 to transmit the first latency sensitive signaling/control traffic in combination with the second plurality of latency sensitive data. In some embodiments, controller block 302 may be adapted to control transmitter block 304 to transmit said latency sensitive signaling/control traffic and latency sensitive data in compliance with an IP.

In some embodiments, transmitter block 304 may be coupled to medium 306 and may be adapted to transmit signals over medium 306. In various embodiments, medium 306 may comprise a wire media, or its equivalent, such as, but not limited to, coaxial, twisted pair, or optical fiber. In various other embodiments, medium 306 may comprise a wireless medium, such as, but not limited to, radio frequency (RF) or infrared (IR) signals transmitted through air, vacuum, etc.

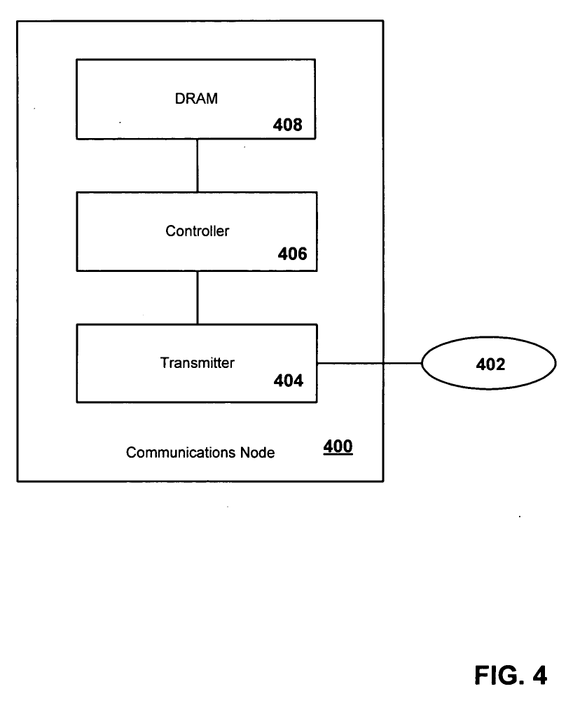

FIG. 4 is a block diagram illustrating some of the functional blocks of a communications node 400, in accordance with an embodiment of this invention. In various embodiments, communications node 400 may include controller block 406. In various embodiments, communications node 400 may include transmitter block 404. Controller block 406 may be coupled to transmitter block 404. In various embodiments, communications node 400 may include dynamic random access memory (DRAM) block 408. Controller block 406 may be coupled to DRAM block 408 and may be adapted to use DRAM block 408 for storage. In various embodiments, DRAM block 408 may comprise any type of DRAM, whether presently known by one skilled in the art or to be devised consistent with an embodiment of this invention, including Synchronous DRAM (SDRAM), double data rate (DDR) SDRAM, and double data rate 2 (DDR2) SDRAM.

In some embodiments, DRAM block 408 may comprise a storage medium having a plurality of instructions stored therein designed to perform at least some of the operations described herein. In some embodiments, controller block 406 may include a controller readable medium (not shown) comprising a storage medium having a plurality of instructions stored therein designed to perform at least some of the operations described herein. In some embodiments where the storage medium is included in controller block 406, the storage medium may comprise of any type of storage medium, including electronic memory, magnetic memory, or any type of past, present, or future storage medium consistent with the principles of an embodiment of this invention.

In various embodiments, controller block 406 may be adapted to combine a first of a plurality of latency sensitive signaling/control traffic with a first of a plurality of latency sensitive data. Controller block 406 may be adapted to control transmitter block 404 to transmit the first latency sensitive signaling/control traffic in combination with the first plurality of latency sensitive data. In various embodiments, controller block 406 may be adapted to consider signaling/control traffic having latency sensitivity in excess of an upper latency threshold as latency sensitive signaling/control traffic. Such a latency sensitivity threshold may be specified in many different ways, including maximum time permitted for transmission between two communications nodes, for example.

In some embodiments, transmitter block 404 may be coupled to medium 402 and may be adapted to transmit signals over medium 402. In various embodiments, medium 402 may comprise a wire media, or its equivalent, such as, but not limited to, coaxial, twisted pair, or optical fiber. In various other embodiments, medium 402 may comprise a wireless medium, such as, but not limited to, radio frequency (RF) or infrared (IR) signals transmitted through air, vacuum, etc.

In various embodiments, communications node 400 may comprise at least part of a wireless network. In some embodiments, communications node 400 may act as an AP. In some embodiments, communications node 400 may include an additional transmitter (not shown). In some embodiments, communications node 400 may include at least one antenna (not shown). In various embodiments, communications node 400 may comprise or be integrated into an 802.11 compliant or compatible access point. In various embodiments, communications node 400 may comprise or be integrated into an 802.16 compliant or compatible access point. Communications node 400 may be compatible with alternative standards or protocols. Communications node 400 may be compatible with multiple standards or protocols. In various embodiments, communications node 400 may comprise a basestation. In various embodiments, communications node 400 may be integrated in any number of electronic devices to augment the electronic devices' abilities. Such electronic devices may include, for example, a personal computer, a set-top box, a game console, a video display, a digital versatile disk (DVD) player, a home entertainment console, and the like.

Thus, it can be seen from the above description, a method of operation in a communications node, wherein a first of a plurality of latency sensitive signaling/control traffic is combined with a first of a plurality of latency sensitive data, and the first latency sensitive signaling/control traffic is transmitted in combination with the first latency sensitive data, is described. Communications nodes and devices, subsystems, and systems equipped to operate in the above manner have also been described. While the present invention has been described in terms of the foregoing embodiments, those skilled in the art will recognize that the invention is not limited to the embodiments described. Other embodiments may be practiced with modification and alteration within the spirit and scope of the appended claims. Accordingly, the description is to be regarded as illustrative instead of restrictive.

What is claimed is

1. A method of operation in a first communications node, the method comprising:
combining a first of a plurality of latency sensitive signaling/control traffic with a first of a plurality of latency sensitive data; and
transmitting the first latency sensitive signaling/control traffic in combination with the first latency sensitive data.

2. The method of claim 1, wherein said plurality of latency sensitive signaling/control traffic have a latency sensitivity in excess of an upper latency threshold of the signaling/control traffic.

3. The method of claim 1, wherein the method further comprises determining whether both latency sensitive data and latency sensitive signaling/control traffic are pending transmission, and the combining and transmitting in combination operations are performed in response to an affirmative result of the determination operation.

4. The method of claim 3, wherein said determining is at least partially based on an accumulated quantity of pending signaling/control traffic.

5. The method of claim 1, wherein the plurality of latency sensitive signaling/control traffic comprises a defined subset of possible signaling/control traffic.

6. The method of claim 1, wherein the method further comprises:
combining the first of a plurality of latency sensitive signaling/control traffic with a second of a plurality of latency sensitive data; and
transmitting the first latency sensitive signaling/control traffic in combination with the second latency sensitive data.

7. The method of claim 1, wherein the first communications node is adapted to support data of a plurality of priority classes, and said latency sensitive data have priority classes above a priority class threshold.

8. The method of claim 1, wherein the first communications node is adapted to support data of a plurality of priority classes, and said first latency sensitive data has a real-time priority class.

9. The method of claim 1, wherein said first latency sensitive signaling/control traffic is associated with said first latency sensitive data.

10. The method of claim 1, wherein the latency sensitive signaling/control traffic comprises information regarding switching from the first communications node to a second communications node.

11. The method of claim 1, wherein the first communications node is at least part of a radio access network.

12. The method of claim 1, wherein said transmitting is in compliance with an Internet Protocol (IP).

13. A communications node comprising:
a transmitter; and
a controller coupled to the transmitter, the controller adapted to combine a first of a plurality of latency sensitive signaling/control traffic with a first of a plurality of latency sensitive data, and control the transmitter to transmit the first latency sensitive signaling/control traffic in combination with the first plurality of latency sensitive data.

14. The communications node of claim 13, wherein the controller is adapted to consider signaling/control traffic having latency sensitivity in excess of an upper latency threshold as latency sensitive signaling/control traffic.

15. The communications node of claim 13, wherein the controller is adapted to determine whether both latency sensitive data and latency sensitive signaling/control traffic are pending transmission, and the controller is adapted to perform the combining and the controlling of the transmitter to transmit in combination, in response to an affirmative result of the determination operation.

16. The communications node of claim 15, wherein said controller is adapted to perform said determining at least partially based on an accumulated quantity of pending signaling/control traffic.

17. The communications node of claim 13, wherein the controller is adapted to support a plurality of signaling/control traffic, and consider a defined subset as latency sensitive signaling/control traffic.

18. The communications node of claim 13, wherein the controller is adapted to support data of a plurality of priority classes, and said first latency sensitive data has a real-time priority class.

19. The communications node of claim 13, wherein the controller is further adapted to
combine the first of a plurality of latency sensitive signaling/control traffic with a second of a plurality of latency sensitive data, and
control the transmitter to transmit the first latency sensitive signaling/control traffic in combination with the second plurality of latency sensitive data.

20. The communications node of claim 13, wherein the communications node is at least part of a radio access network.

21. The communications node of claim 13, wherein the controller is adapted to control the transmitter to transmit said latency sensitive signaling/control traffic and latency sensitive data in compliance with an Internet Protocol (IP).

22. A system comprising:
a dynamic random access memory (DRAM); and
a communications node including
a transmitter, and
a controller, the controller coupled to the DRAM and adapted to use the DRAM for storage, the controller coupled to the transmitter and adapted to
combine a first of a plurality of latency sensitive signaling/control traffic with a first of a plurality of latency sensitive data, and
control the transmitter to transmit the first latency sensitive signaling/control traffic in combination with the first latency sensitive data.

23. The system of claim 22, wherein the controller is adapted to consider signaling/control traffic having latency sensitivity in excess of an upper latency threshold as latency sensitive signaling/control traffic.

24. The system of claim 22, wherein the communications node comprises a selected one from the group consisting of a wireless access point and a basestation.

25. The system of claim 22, wherein the communications node comprises a selected one from the group consisting of a set-top box, a game console, a digital versatile disk player, a home entertainment console, and a video display.

26. A controller readable medium comprising:
a storage medium; and
a plurality of instructions stored in the storage medium, the instructions designed to enable an apparatus to
combine a first of a plurality of latency sensitive signaling/control traffic with a first of a plurality of latency sensitive data, and
transmit the first latency sensitive signaling/control traffic in combination with the first latency sensitive data.

27. The controller readable medium of claim 26, wherein said plurality of latency sensitive signaling/control traffic have a latency sensitivity in excess of an upper latency threshold of the signaling/control traffic.

28. The controller readable medium of claim 26, wherein the instructions are further designed to determine whether both latency sensitive data and latency sensitive signaling/control traffic are pending transmission, and the combining and transmitting in combination operations are performed in response to an affirmative result of the determination operation.
